(19) United States
(12) Patent Application Publication
(10) Pub. No.: US 2026/0090514 A1
(43) Pub. Date: Apr. 2, 2026

(54) Multi-Component Pet Bed Assembly

(71) Applicant: Matthew Ray Little, Bellingham, WA (US)

(72) Inventor: Matthew Ray Little, Bellingham, WA (US)

(21) Appl. No.: 18/750,237

(22) Filed: Jun. 21, 2024

(51) Int. Cl. A01K 1/035

(52) U.S. Cl. CPC A01K 1/0353

(57) ABSTRACT

A multi-component pet bed assembly composed of a top and base. The assembly can be round, oval, square, rectangular or triangular in shape, and may include handles on the sides for transport. The top and base components connect via corresponding fasteners, such as magnets, snap buttons, zippers, hook and loop or other methods of securing, allowing for easy attachment/detachment or separation from one another, the detachable top able to be used independent of the base. Both components comprise an inner core, such as an inflatable bladder/cushion, foam, batting or other supportive material, encased in a removable outer fabric or material that allows for independent cleaning and/or replacement. The outer fabric or material may be made from various decorative/cosmetic and/or functional materials, which may be durable, potentially waterproof or water-resistant, and/or may consist of a non-slip bottom surface to resist movement on different surfaces or floor types.

### RELATED APPLICATIONS

This application claims the benefit of the U.S. Provisional Application Ser. No. 63/511,884 filed Jul. 4, 2023, which is hereby incorporated by reference in its entirety.

### FIELD OF THE INVENTION

This invention relates to animal or pet products, in particular to animal or pet bed construction and improved features.

### BACKGROUND OF INVENTION

Conventional animal and/or pet beds consist of a single supportive material or core, such as and foam, that is encased in a nonremovable cover or outer layer. The construction and core material does not allow for easy maintenance, cleaning or replacement resulting in these type embodiments being disposed of after becoming soiled or otherwise damaged, be it from prolonged use, wear and tear, or from repeated attempts to clean as the design and materials are not suited, as the foam core will deteriorate and break down quickly from attempts to wash/dry, as well as this type of embodiment being too bulky to easily wash/dry.

Others animal and/or pet beds may consist of a removable cover or outer layer that encases that supportive core material, allowing for easier cleaning. However, the supportive core material, such as foam, is typically not cleanable as mentioned above, nor are the covers or outer encasement layer replaceable, thus resulting in these type embodiments being disposed of after becoming repeatably soiled or otherwise damaged, be it from prolonged use, wear and tear, or from repeated attempts to clean.

Additional designs disclose the use of a removable and even washable sheet, mat or blanket that is attached to the top surface of the embodiment or detached from a bottom embodiment or base. The top surface however, being a mat or blanket, does not offer supportive features apart from the base and requires the mat, blanket or top sheet to be used in conjunction with the base or bottom of the bed assembly and not independently.

While these types of embodiments may be suitable for the particular purpose to which they address, they would not be as suitable for the purposes of the present invention as heretofore described. A need exists for an improved animal or pet bed assembly that permits multi-component modularization of usage, assembled as well as independently, also allowing for selectable supportive attributes, selectable materials or fabrics to customize individual function or cosmetic preference, with the ability to select such features with the intent to use, interchange, or replace them independent of each other, while providing a more sustainable, economical and environmentally conscious solution of renewing and extended the use and longevity of the bed assembly by allowing the easy cleaning, care and maintenance, as well as replacement of the comprised parts of the assembly independently.

### SUMMARY OF THE INVENTION

It is the intent of the invention to provide an improved animal or pet bed assembly that permits multi-component modularization of usage, selectable supportive attributes, selectable materials or fabrics to customize function or cosmetic appearance, as well as the ability to select such features with the intent for specific use and access to interchange or replace them independent of each other, as well as the independent use of the top component separate of the base component.

It is a further intent of the invention to provide a more sustainable, economical and environmentally conscious solution of renewing and extended the use and longevity of the bed assembly by allowing the access for cleaning, care and maintenance, as well as the potential replacement of the comprised parts of the assembly independently.

In accordance with the first intent of this invention, the multi-component animal or pet bed assembly is comprised of a top and base which each consisting of a horizontal supportive pad, mattress or cushion consisting of an accessible inner core encased in an outer layer. The top and base components of the bed assembly each having one side consisting of corresponding fasteners or securing material, such as magnets, snap buttons, zippers, hook & loop, or other methods for securing, which allow for the ability to separate by attaching and detaching from one another. The base component of the bed assembly including one or more handles on the sides to facilitate transport of the full assembly more easily, while the top component of the bed assembly is intended to be detachable for separate and independent use when the full assembly is not feasible or desired, such as during commute or travel that might be compromised by transporting the entire assembly together. Additionally, the top component assembly consists of a cover or outer layer of any variety of decorative/cosmetic and/or functional fabric or material such as but not limited to leather, wool, sheepskin, or cotton fabric that may have a design pattern having a fixed panel or panel opening, sealable by fasteners or securing material, such as magnets, snap buttons, zippers, hook & loop, or other methods for securing, that allows access to its inner core permitting supportive options based on the pet or animal needs or requirements such as foam, inflatable bladder, or pillow consisting of batting, feather down, foam beads or other supportive material being fixed or removable and/or interchangeable, while the base assembly consists of a its own inner core which permits additional supportive options based on the pet or animal needs or requirements such as foam, inflatable bladder, or pillow consisting of batting, feather down, foam beads or other supportive material that is accessible, removable and/or interchangeable by its panel opening, that is sealable by fasteners or securing material, such as magnets, snap buttons, zippers, hook & loop, or other methods for securing on its cover or outer layer of any variety of decorative/cosmetic and/or functional fabric or material which may be waterproof or water-resistant such as but not limited to leather or a durable ballistic nylon, and a bottom fabric or material of that base component being of an different or individual fabric or material of any variety which may be a non-slip material or fabric that aids in keeping the entire bed stationary during use of entering or exiting.

In accordance with the further intent of this invention, the multi-component animal or pet bed assembly being comprised of interchangeable parts, such as the top, top cover and supportive inner core, base, base cover and supportive inner core that allow for cleaning, maintenance and/or replacement of all comprised parts of the bed assembly independent of each other, this promotes an economic savings aspect by not having to replace the entire bed due to degradation of material from repeated use, wear or tear, accidents, repeated cleaning, or even just the desire of a change the cosmetic appearance, instead replacing only the required component such as the top, base or inner core independently. Additionally, this promotes the pet assembly to be considered more sustainable and an environmentally conscious solution as a result of only renewing particulate aspects without disposing of or having to replace the bed in its entirety, extending the use and longevity of the bed assembly by allowing the cleaning, care and maintenance, as well as the potential replacement, of the comprised parts independently.

The characteristics of this invention are novel and provide a solution to reduce the unnecessary disposal of animal or pet beds when certain aspects of current and typical beds have reached the end of use, only to be then replaced by another that shares the same fate. The removable and interchangeable parts allow for the customization of this animal or pet bed assembly for particular or specific use based on individual situations or pet requirements. Additionally, the bed assembly allows for easy maintenance by being able to clean the top and the base cover separately and easily while having the option to utilize a backup or replacement top that can alternated between uses or to implement different fabrics choices based on the season or specific use, while also allowing for utilization of the top of the animal or pet bed assembly separate of the base during travel or commuting when the full assembly is not feasible, required or needed, as well as providing the ability to replace only particular comprised parts of the assembly instead of having to replace the bed in its entirety.

### BRIEF DESCRIPTION OF DRAWINGS

FIG. 1 is a perspective view of the multi-component animal or pet bed assembly (1) that is constructed according to the preferred embodiment of the invention;

FIG. 2 is a perspective exploded view of the multi-component animal or pet bed assembly that is depicted in FIG. 1 that displays the top (2) component and base (3) component;

FIG. 3 is a multi-perspective view of the top (2) component of the animal or pet bed assembly that displays the cover/outer layer (4), panel opening (5), fixed panel (6), and supportive inner core options (7a-c).

FIG. 4 is a multi-perspective view of the underside of the top (2) component of the animal or pet bed assembly that displays the cover/outer layer (4), panel opening (5), fixed panel (6), and fasteners/securing material options (8a-d) that correspond to the base component;

FIG. 5 is a multi-perspective view of the base (3) component of the animal or pet bed assembly that displays the cover/outer layer (10), handle (9), panel opening (11), and supportive inner core options (12a-c);

FIG. 6 is a multi-perspective view of the base (3) component of the animal or pet bed assembly that displays the cover/outer layer (10), handle (9), panel opening (11), and fasteners/securing material options (8a-d) that correspond to the top component;

FIG. 7 is a multi-perspective view of the animal or pet bed assembly that displays a combined view of the top (2) component with cover/outer layer (4), panel opening (5) and fixed panel (6), base (3) component with cover/outer layer (10), handle (9), panel opening (11), and corresponding fasteners/securing material options (8a-d) of the top (2) component and base (3) component;

FIG. 8 is a perspective view of the underside of the multi-component animal or pet bed assembly depicted in FIG. 1 that displays the top (2) component with cover/outer layer (4) and panel opening (5), base (3) component with cover/outer layer (10), panel opening (11) and bottom surface (13);

FIG. 9 is a multi-fragmentary cross-sectional view of the horizontal side of the multi-component animal or pet bed assembly depicted in FIG. 1 that displays the top (2) component with cover/outer layer (4), fasteners/securing material (14a-c) of the panel opening (5) and fixed panel (6) to the supportive inner core (7a-d), base (3) component with cover/outer layer (10), fasteners/securing material (15a-d) of the panel opening (11) to the supportive inner core (12a-c), bottom surface (13), and corresponding fasteners/securing material options (8a-d) of the top (2) component and base (3) component.

### DETAILED DESCRIPTION OF THE INVENTION

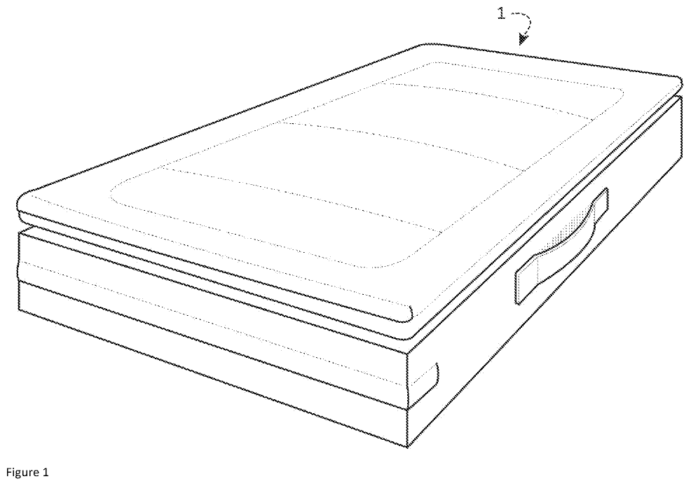

With reference to the drawings, FIG. 1 depicts a rightside-up perspective view of the combined multi-component animal or pet bed assembly (1) comprising the upper horizontal component and a lower horizontal component that can be attached/detached or otherwise separated.

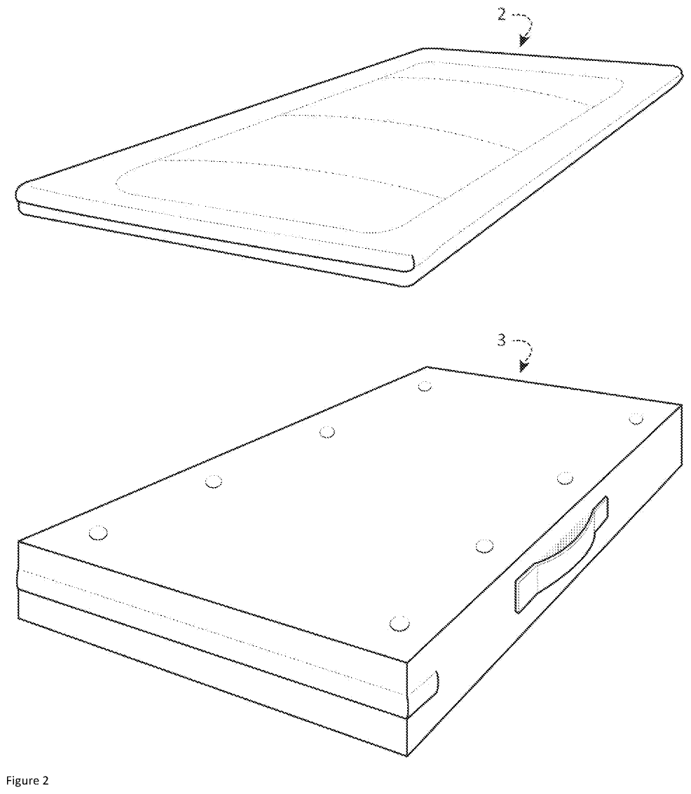

With reference to FIG. 2, showing an exploded rightside-up perspective view of the separated upper horizontal component serving as the top (2) and the lower horizontal component serving as the base (3) of the animal or pet bed assembly, both the top (2) and base (3) components consisting of a cover or outer layer of fabric or material that encases supportive inner cores, and the top (2) and base (3) components consisting of a corresponding surface for attaching/detaching or otherwise separating from one another.

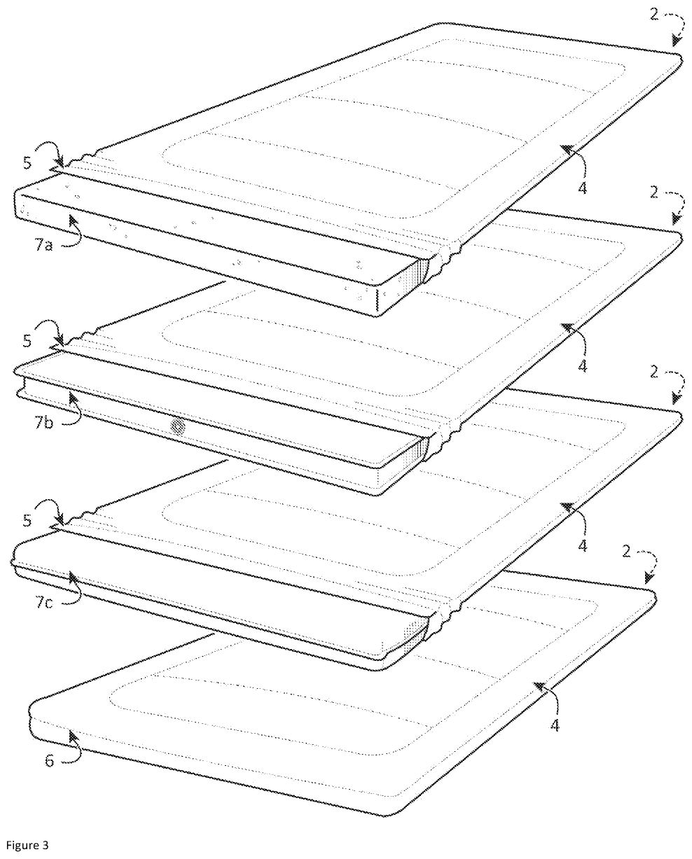

With reference to FIG. 3, showing a rightside-up multi-perspective view of the separate and detached upper horizontal component serving as the top (2) of the animal or pet bed assembly comprising a cover or outer layer (4) of any variety of decorative/cosmetic and/or functional fabric or material which may be waterproof or water-resistant, a fixed panel (6) or panel opening (5) being sealable by fastener or other method of securing that serves as access to a supportive inner core (7a-c) or fixed panel which consist of foam (7a), inflatable bladder (7b), or pillow (7c) consisting of batting, feather down, foam beads or any other supportive material.

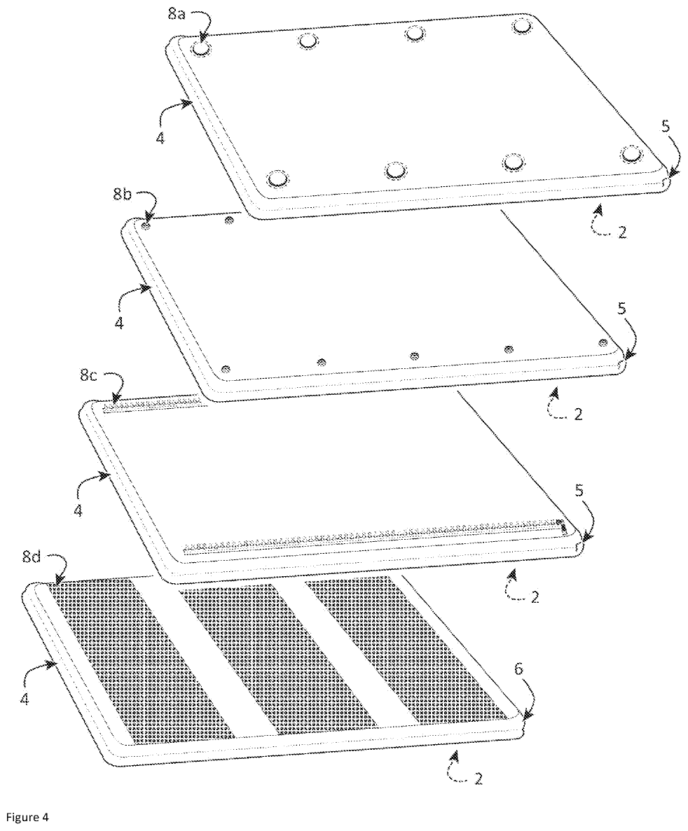

With reference to FIG. 4, showing an upside-down multi-perspective view of the separate and detached upper horizontal component serving as the top (2) of the animal or pet bed assembly comprising a fixed panel (6) or panel opening (5) that serves as access to a supportive inner core encased by a cover or outer layer (4) which has an underside surface consisting of fasteners or securing material (8a-d) such as magnets (8a), snap buttons (8b), zippers (8c), hook & loop (8d) or other method for securing to facilitate the attachment/detachment or otherwise separation from the lower horizontal component serving as the base of the animal or pet bed assembly.

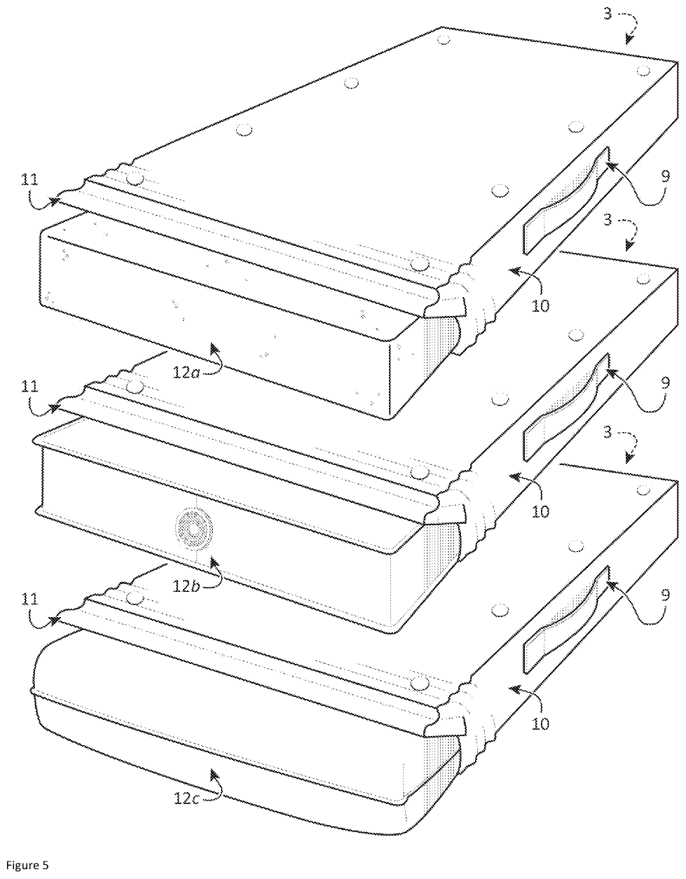

With reference to FIG. 5, showing a rightside-up multi-perspective view of the separate and detached lower horizontal component serving as the base (3) of the animal or pet bed assembly comprising a cover or outer layer (10) of any variety of decorative/cosmetic and/or functional fabric or material which may be waterproof or water-resistant, one or more handles (9) on the sides for transport of the bed assembly, a panel opening (11) being sealable by fastener or other method of securing that serves as access to a supportive inner core (12a-c) which consist of foam (12a), inflatable bladder (12b), or pillow (12c) consisting of batting, feather down, foam beads or any other supportive material.

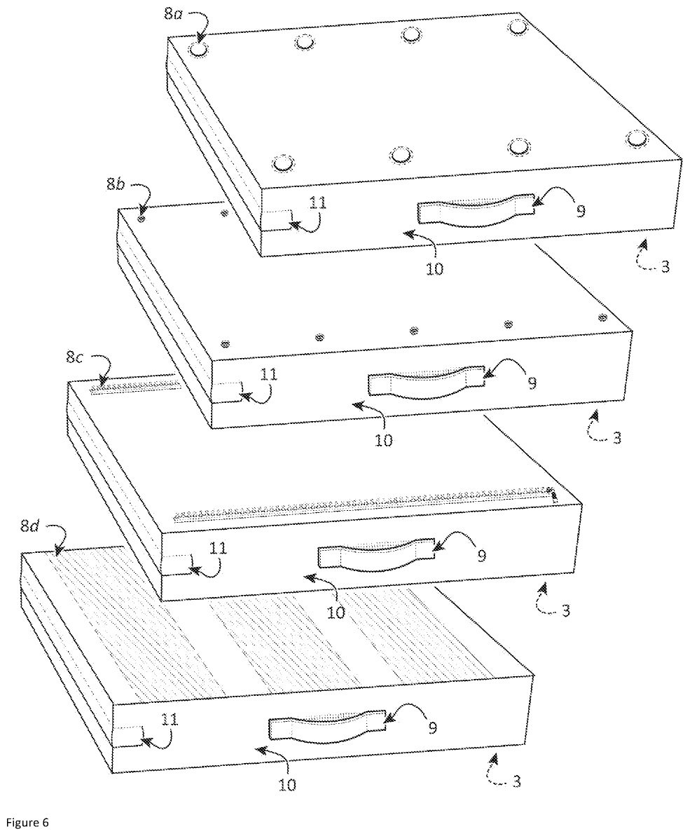

With reference to FIG. 6, showing a rightside-up multi-perspective view of the separate and detached lower horizontal component serving as the base (3) of the animal or pet bed assembly comprising a cover or outer layer (10) which has an upper-side surface consisting of fasteners or securing material (8a-d) such as magnets (8a), snap buttons (8b), zippers (8c), hook & loop (8d) or other method for securing to facilitate the attachment/detachment or otherwise separation from the upper horizontal component serving as the top of the animal or pet bed assembly, one or more handles (9) on the sides for transport of the bed assembly, and a panel opening (11) being sealable by fastener or other method of securing that serves as access to a supportive inner core.

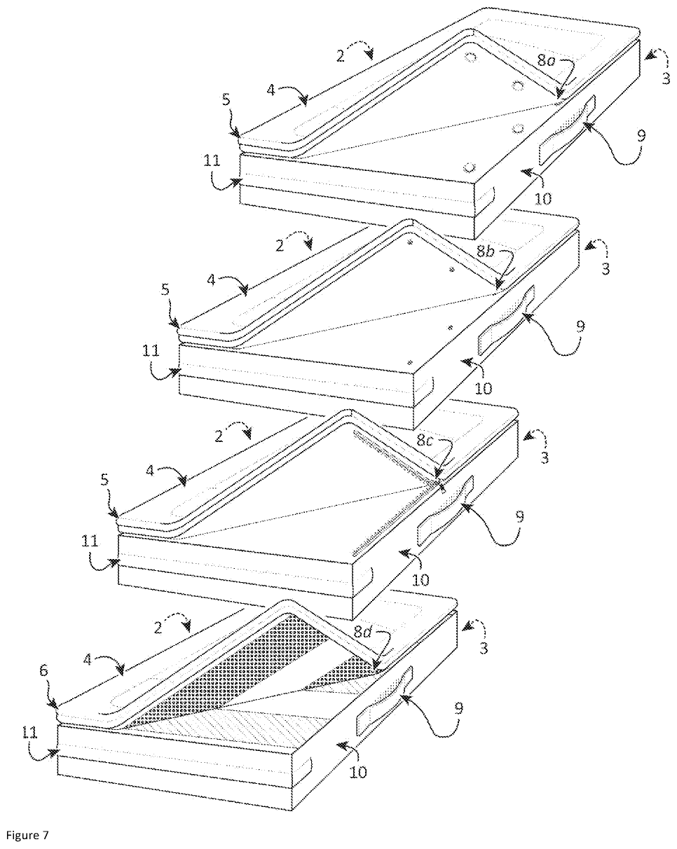

With reference to FIG. 7, showing a rightside-up multi-perspective view of the combined upper horizontal component serving as the top (2) and the lower horizontal component serving as the base (3) of the animal or pet bed assembly comprising of one or more handles (9) on the sides of the base (3) component for transport of the bed assembly, cover or outer layer (10) and panel opening (11) that serves as access to the supportive inner core of the base (3) component, cover or outer layer (4) with a fixed panel (6) or panel opening (5) that serves as access to the supportive inner core of the top (2) component, and corresponding fasteners or securing material (8a-d) such as magnets (8a), snap buttons (8b), zippers (8c), hook & loop (8d) or other method for securing to facilitate the attachment/detachment or otherwise separation of the top (2) and base (3) components of the animal or pet bed assembly.

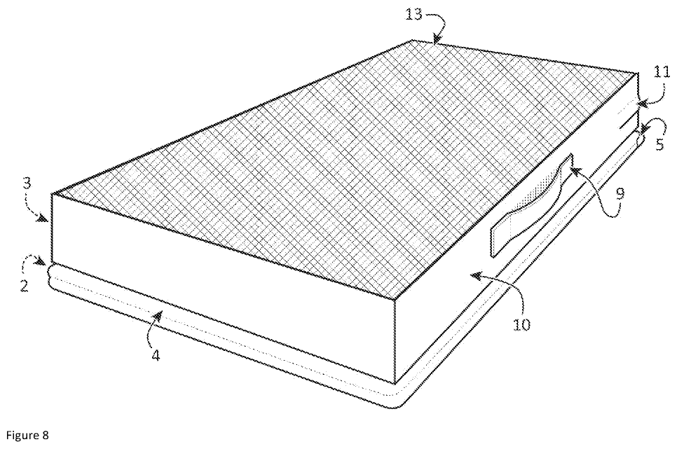

With reference to FIG. 8, showing an upside-down perspective view of the multi-component animal or pet bed assembly depicted in FIG. 1 comprising an upper horizontal top (2) component and a lower horizontal base (3) component that can be attached/detached or otherwise separated from one another, cover or outer layer (10) with one or more handles (9) on the sides for transport and a panel opening (11) that serves as access to the supportive inner core of the base (3) component with a bottom surface (13) of the underside consisting of any variety of decorative/cosmetic and/or functional fabric or material which may be non-slip, waterproof and/or water-resistant, cover or outer layer (4) with a fixed panel or panel opening (5) that serves as access to the supportive inner core of the top (2) component.

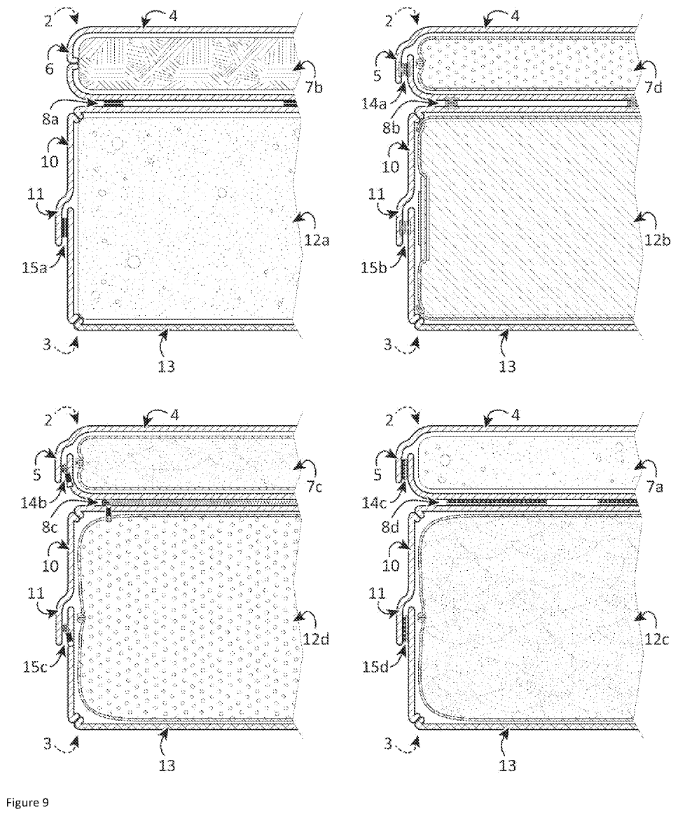

With reference to FIG. 9, showing a multi-fragmentary cross-sectional view of the horizontal side of the multi-component animal or pet bed assembly comprising the top (2) component and base (3) component, the base (3) component consisting of a cover or outer layer (10) with a bottom surface (13) and a panel opening (11) being sealable by fastener or other method of securing (15a-d) such as magnets (15a), snap buttons (15b), zippers (15c), hook & loop (15d) or other method for securing that serves as access to a supportive inner core (12a-d) which consist of foam (12a), inflatable bladder (12b), or pillow consisting of batting, feather down (12c), foam beads (12d) or any other supportive material, and the top (2) component consisting of a cover or outer layer (4) with a fixed panel (6) or panel opening (11) being sealable by fastener or other method of securing (14a-c) such as magnets, snap buttons (14a), zippers (14b), hook & loop (14c) or other method for securing that serves as access to a supportive inner core (7a-d) which consist of foam (7a), inflatable bladder, or pillow consisting of batting (7b), feather down (7c), foam beads (7d) or any other supportive material, both the top (2) and base (3) components of the animal or pet bed assembly consisting of corresponding fasteners or securing material (8a-d) such as magnets (8a), snap buttons (8b), zippers (8c), hook & loop (8d) or other method for securing to facilitate the attachment/detachment or otherwise separation from each other.

While embodiments and characteristics incorporating the principles of the present disclosure have been disclosed in the foregoing description, together with details of the structure and function of the invention, the present disclosure is not limited to the disclosed embodiments and characteristics. Instead, this application is intended to cover any variations, uses, or adaptations of the disclosure using its general principles. Further, the disclosure is illustrative, and changes may be made in detail, especially in matters of size, shape, material and/or arrangement of parts within the principles of the invention to the full extent indicated by the broad general meaning of the terms which fall within the limits of the appended claim.

What is claimed is new and desired to be protected by the patent is set forth in the appended claims:

1. A multi-component bed assembly for an animal and/or pet comprising, in combination:
a) An upper horizontal component serving as the top of the bed assembly that has a cover or outer layer of fabric or material encasing a supportive inner core that may be accessible by a panel opening or inaccessible with a fixed panel;
b) A lower horizontal component serving as the base of the bed assembly that has a cover or outer layer of fabric or material encasing a supportive inner core that may be accessible by a panel opening.

2. The multi-component bed assembly as recited in claim 1, wherein said upper horizontal component serving as the top and lower horizontal component serving as the base share a surface for being attached/detached or otherwise separated from one another:
a) The upper horizontal component serving as the top of the bed assembly that has a bottom surface consisting of fasteners or securing material such as magnets, snap buttons, zippers, hook & loop type or other method for securing to facilitate the attachment/detachment or separation of the corresponding detachable lower horizontal component serving as the base;
b) The lower horizontal component serving as the base of the bed assembly that has a top surface consisting of fasteners or securing material such as magnets, snap buttons, zippers, hook & loop or other method for securing to facilitate the attachment/detachment or separation of the corresponding detachable upper horizontal component serving as the top.

3. The multi-component bed assembly as recited in claim 1, wherein said lower horizontal component serving as the base is comprised of features to enhance its use:
a) The lower horizontal component serving as the base of the bed assembly features one or more handles on its perimeter or sides to facilitate transport;
b) The lower horizontal component serving as the base of the bed assembly features a non-slip bottom material to aid in keeping the bed stationary during use of entering or exiting.
